(19) United States
(12) Patent Application Publication
(10) Pub. No.: US 2003/0204617 A1
(43) Pub. Date: Oct. 30, 2003

(54) Satellite internet communication system and method

(75) Inventors: Luiz Buchsbaum, Great Falls, VA (US); Tokuo Oishi, Vienna, VA (US); Carlos Placido, Rockville, MD (US)

Correspondence Address: SUGHRUE MION, PLLC, 2100 PENNSYLVANIA AVENUE, N.W., WASHINGTON, DC, 20037, US

(73) Assignee: INTELSAT

(21) Appl. No.: 10/128,361

(22) Filed: Apr. 24, 2002

(51) Int. Cl. G06F 15/173

(52) U.S. Cl. 709/236; 709/238

(57) ABSTRACT

A method and system of communication between an IP backbone Internet Service Provider (ISP) and remote Internet service providers via a shared channel on a satellite is provided. At a first router coupled to the IP backbone ISP, a static route for an IP packet of the IP backbone ISP is determined based on a media access control (MAC) address of a destination router of the IP packet. The IP packet is encapsulated and transported in a frame having the MAC address of the destination router based on the static route. Next, the frame/IP packet is received in a second router coupled to the remote ISP, which either drops the IP packet prior to reaching the remote ISP, or transports the IP packet to a final destination in the remote ISP, based on the MAC address of the IP packet destination and a MAC address of the second router.

### BACKGROUND OF THE INVENTION

1. Field of the Invention

The present invention relates to a method and system for sharing high speed downstream satellite capacity among several remote ISPs, and more specifically, for using the media access control (MAC) communication layer of the Open System Interconnection (OSI) model to communicate between an IP backbone service provider and a plurality of remote service providers.

2. Background of the Related Art

Related art high speed Internet connectivity with related art single carrier per channel (SCPC) technology requires two separate satellite carriers for every point-to-point link. FIG. 1 illustrates a related art high speed SCPC system with asymmetric traffic. When an Internet Protocol (IP) backbone service provider 1 serves two or more remote Internet service providers (ISPs) 2a, 2b . . . 2n via a satellite 3, two carriers (e.g., 4a, 4b) must be individually set up per point-to-point link (e.g., 5). The IP backbone service provider 1 has a related art router 106, and each of the remote ISP's 2a . . . 2n has a respective related art router 107a . . . 107n. This related art scheme is possible because Internet traffic is normally asymmetric (e.g., 45 Mbit/s downstream and 8 Mbit/s upstream). The related art foregoing SCPC system requires 2n satellite carriers (e.g., 4a, 4b) to be set up to connect the IP backbone service provider 1 with n remote ISP's 2a . . . 2n.

Although related art ISP's are connected to the related art IP backbone service provider 1 by separate point-to-point links, this related art system has various problems and disadvantages. For example, but not by way of limitation, the use of separate downstream carriers (e.g., 4a, 4c, 4e) wastes more transponder power and bandwidth than a shared high speed carrier. As with a single high speed carrier, no intermodulation products are present, higher data rate and power are possible due to the ability of single-carrier operation to achieve near transponder saturation. Additionally, in the related art system, ISP's 2a, 2b . . . 2n must dimension their respective downstream carriers 4a, 4c, 4e for peak traffic requirements, resulting in unused capacity the rest of the time. Also, the use of separate SCPC carriers is not hardware efficient, because separate modulators (and possibly conversion chains) are required for each of the downstream links.

In the related art system of FIG. 1, satellite capacity for IP traffic may be optimized in three ways. First, related art layer 1 (i.e., the physical layer in the Open System Interconnection (OSI) model) technologies that use advanced bandwidth access tools, such as dynamic Time Division Multiple Access (TDMA) or (Multiple Frequency TDMA) (MF-TDMA), can be implemented. However, these related art advanced bandwidth access tools use dynamic allocation of RF bandwidth and thus have the related art problems of added operating complexity. Additionally, issues such as synchronization, signaling and contention in a high latency environment result in a requirement that specific devices perform these functions.

Second, related art layer 2 protocols such as digital video broadcasting (DVB), asynchronous transfer mode (ATM) and frame relay (FR) can be used for encapsulation. However, each of the related art layer 2 protocols has various disadvantages.

For example, but not by limitation, with respect to DVB, although some implementations use the point-to-multipoint capabilities of the related art DVB standard to encapsulate IP, DVB is less hardware efficient because the related art routers do not support DVB framing. As a result, in addition to satellite modem and router equipment, a separate set of devices is required at each terrestrial station to perform the IP to DVB encapsulation. Further, the related art methods used to encapsulate IP packets into DVB frames are non-standard. Because the frame has a fixed size, it is necessary to fill empty spaces when the IP packets are not exact multiples of 188 bytes.

With respect to ATM, it is necessary to include specific related art devices, such as ATM switches. Since ATM maintains a fixed cell size, the aforementioned related problems of DVB also apply to ATM. Further, testing conducted on ATM over satellite shows that the single bit correction capability of ATM results in additional vulnerability to bursty errors conventionally found in satellite communications.

For FR, a point-to-multipoint configuration is possible by making use of the related art FR assembler-disassembler (FRAD) and/or related art FR switches or routers. For at least the same reasons as described above with respect to DVB, the use of FRAD's or FR switches have the disadvantage of reducing hardware efficiency.

Third, at layer 3, the related art bent pipe technology is used with related art SCPC services and bandwidth sharing enforced at layer 3. Prior to use of bent pipe technology, layer 3 bandwidth sharing was accomplished in the related art SCPC satellite technology based on specific IP policies (at layer 3), set up at related art routers. The IP policies decide whether IP packets from the satellite were intended for their respective networks. More specifically, the IP packets are stripped from their layer 2 encapsulation and checked against policy based entries or the IP routing table for processing.

However, the related art layer 3 approach also has various problems and disadvantages. For example, but not by way of limitation, the related art layer 3 approach results in routing loops, as discussed below. Usually, remote related art routers have a default configuration that points to the core of the related art network, to assure that every IP packet with an unknown destination will be sent to the core router connected to the rest of the network. When the related art remote router processes a IP packet at layer 3, which is not intended for use by any of its attached networks, the remote router sends the IP packet back to the core router. Since the core router is connected to the destination through a shared pipe, the core router will again send the IP packet through the shared pipe if the IP packet is intended for another of the other ISP's sharing the downstream link (i.e., a routing loop). As a result, bandwidth is wasted.

Another related art problem arising from the related art layer 3 approach is excessive use of the router's CPU. To avoid the aforementioned related art routing loop problem, configuration of specific policy-based routing entries is required to ensure that each related art router drops the IP packet destined to one of the other ISP's sharing the link, instead of sending routing entries back to the core router (i.e., default route). The related art policy based routes are very CPU intensive. Routers that determine what to do with IP packets intended for other ISPs restrict themselves from performing at the throughput level required, thus resulting in frequent IP packet losses.

Further, the related art layer 3 approach also results in scalability problems. The aforementioned approach of creating policy-based entries is not scalable, because specific entries are required for all related networks that do not belong to the ISP's (e.g., networks that belong to any of the other remote ISP's sharing the link). As a result, for every new ISP added to the shared link, a new set of entries that includes all of the IP addresses of the ISP must be configured in each of the existing routers connected to that same link. The additional entries that are present require a router to check for new policies before looking to the routing table, which results in the aforementioned related art CPU and operating complexity problems.

### SUMMARY OF THE PRESENT INVENTION

It is an object of the present invention to overcome at least the aforementioned related art problems and disadvantages.

Additionally, it is an object of the present invention to provide a shared downstream satellite link that transports an IP packet to remote ISPs, and through use of media access control layer addressing, only transports the IP packet to its intended downstream IP router.

It is another object of the present invention is to provide an inexpensive and scalable solution to effectively utilize static satellite capacity for Internet interconnection, or any service that makes use of the IP protocol. Savings in satellite capacity and IP statistical multiplexing gains are realized by applying the present invention, enabling efficient transparent Internet connectivity.

To achieve at least the foregoing objects, a method of communication between a first Internet Service Provider (ISP) and at least one second Internet Service Provider (ISP) via a satellite is provided, including the steps of (a) at a first router coupled to the first ISP, determining a static route for an IP packet of the first ISP in accordance with a media access control (MAC) address of a destination router for the IP packet, (b) encapsulating and transporting, via the satellite, the IP packet in a frame having the MAC address of the destination router in accordance with a static entry in an address resolution protocol (ARP) table, (c) in a second router coupled to the at least one second ISP, receiving the frame containing the IP packet, and (d) making a transportation decision for the IP packet prior to arrival at the at least one second ISP.

Additionally, a system for satellite communication between a first Internet Service Provider (ISP) and at least one second ISP is provided, including a first router coupled to the first ISP and a second router coupled to the second ISP, and a shared channel configured to encapsulate an IP packet in a frame and the frame containing the IP packet from the first ISP to the at least one second ISP in accordance with a media access control (MAC) address determined in the first router. Further, in this system, the second router is operative to either (a) drop the IP packet prior to reaching the at least one second ISP, or (b) transport the IP packet to a final destination in the at least one second ISP, in accordance with the MAC address of the IP packet and a MAC address of the second router.

### BRIEF DESCRIPTION OF THE DRAWINGS

The accompanying drawings, which are included to provide a further understanding of exemplary embodiments of the present invention and are incorporated in and constitute a part of this specification, illustrate embodiments of the invention and together with the description serve to explain the principles of the drawings.

FIG. 1 illustrates a related art satellite-based Internet system;

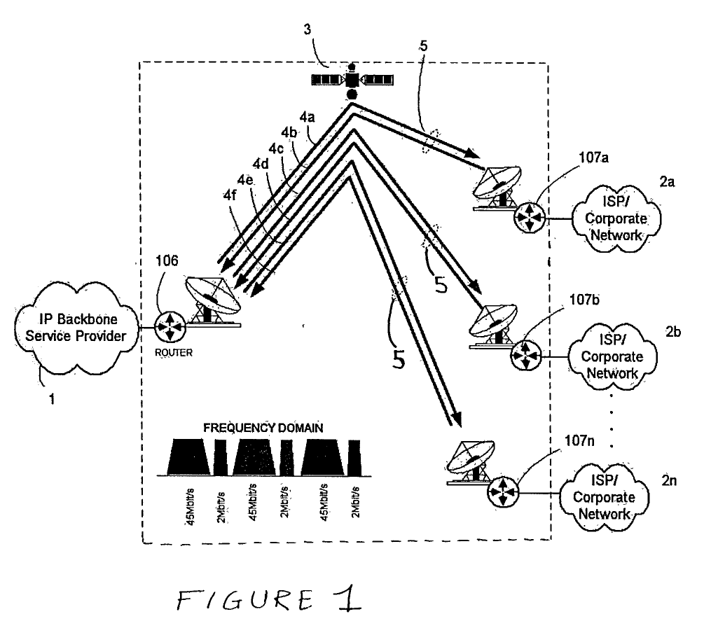

FIG. 2 illustrates a satellite-based Internet communication system according to an exemplary embodiment of the present invention;

FIG. 3 illustrates additional details of the satellite-based Internet communication system according to embodiment of the present invention;

FIG. 4 illustrates an exemplary method of the present invention; and

FIG. 5 illustrates an exemplary embodiment of the present invention applied to a full mesh network.

### DETAILED DESCRIPTION OF THE PRESENT INVENTION

Reference will now be made in detail to the exemplary embodiment of the present invention, examples of which are illustrated in the accompanying drawings. In the present invention, the terms are meant to have the definition provided in the specification, and are otherwise not limited by the specification.

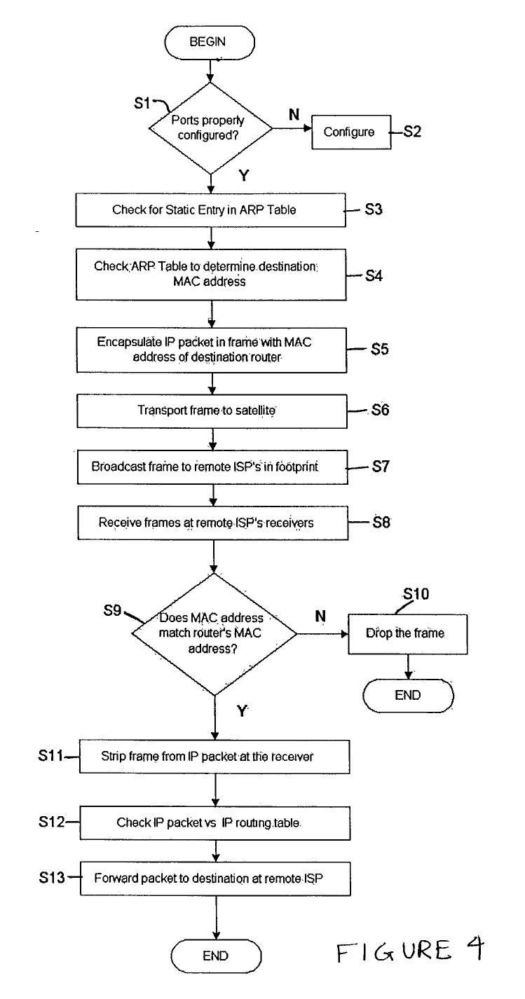

The present invention improves utilization of satellite bandwidth in SCPC-based point-to-multipoint Internet connectivity scenarios by combining and configuring various components in a novel manner, and relying on characteristics of layers 1, 2 and 3 that are present in a satellite based Internet connection. For example, but not by way of limitation, at layer 1 (i.e., physical layer in the Open System Interconnection (OSI) model), transparent satellite links are represented, and at layer 2 (i.e., data link layer), MAC addressing is represented. Further, at layer 3 (i.e., network layer), IP routing is represented. A novel feature of the exemplary embodiment of the present invention is use of MAC addressing at layer 2 to segregate IP packets prior to their arrival at remote ISP networks. The process for the aforementioned novel feature is described in greater detail below with respect to Tables 1-4, and illustrated in FIG. 4.

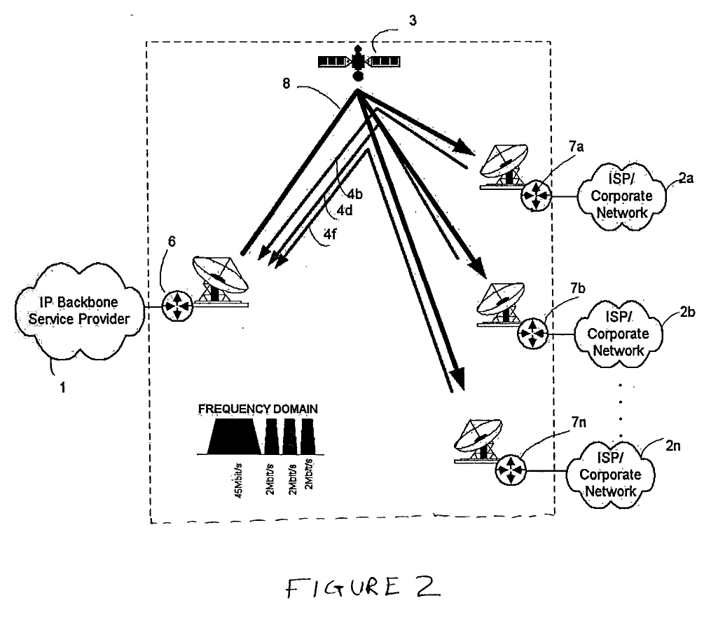

FIG. 2 illustrates an exemplary embodiment of the present invention. A single high-speed satellite carrier 8 is shared by several remote ISP's 2a . . . 2n (e.g., corporate customers) for Internet (or IP) interconnection in the downstream direction. Upstream transmission is performed using conventional non-shared carriers 4b, 4d, 4f. For example, but not by way of limitation, one 45 Mbit/s carrier 8 and three 2 Mbit/s carriers 4b, 4d, 4f represent shared downstream and individual upstream satellite carriers, respectively. However, the present invention is not limited thereto, and can be applied to any combination of communication rates and any number of remote sites. Further, the present invention can be applied to any network, including, but not limited to, a star topology (i.e., point-to-multipoint) and a fully meshed topology, which permits “any connectivity” configuration.

By the use of transparent satellite modulators, demodulators and routers (such as those provided by Nortel Networks), an asymmetric point-to-multipoint scenario is enforced for the media access control (MAC) layer of the remote ISP via an address resolution protocol (ARP) table (i.e., in the layer 2 protocol). The routers 6, 7a . . . 7n in the present invention include at least an IP routing table and the aforementioned ARP routing table (see Tables 1-4). As a result, efficient sharing of high-speed downstream satellite capacity among several remote ISP's is achieved, and the present invention produces bandwidth savings and the capacity for remote ISP's to receive bursts of IP traffic. Further, the present invention, in conjunction with policies, allows time-of-the-day rate rotation of downstream traffic.

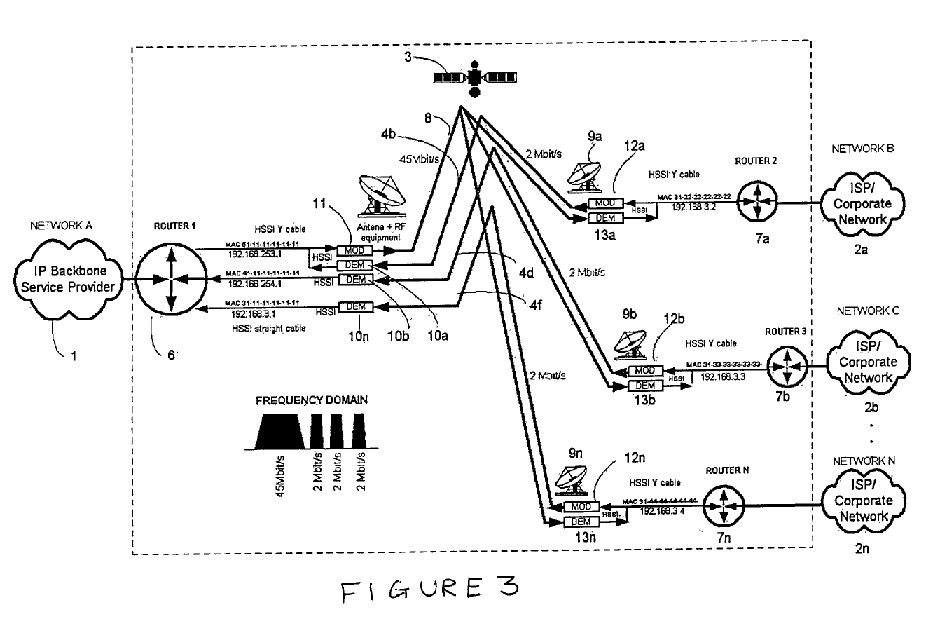

In contrast to the related art high speed SCPC system, the present invention, illustrated in FIG. 2, only requires n+1 total carriers 4b, 4d, 4f, 8 to connect the IP backbone service provider 1 with n remote ISPs 2a . . . 2n, where n represents the number of remote ISP's connected to the IP backbone service provider 1. A related art satellite network would require 2n modulators and 2n demodulators when using separate point-to-point connections. However, as illustrated in FIG. 3, when using a point-to-multipoint connection, n+1 modulators 11, 12a, 12b . . . 12n and 2n demodulators 10a, 10b . . . 10n, 13a, 13b . . . 13n are required. While FIG. 3 illustrates the present invention for n=3, the present invention is not limited thereto, and may contain any number n of remote ISP's connected to the backbone.

Thus, a point-to-multipoint system requires fewer modulators than the related art separate, point-to-point system by a ratio of (n+1)/(2n). As the number of points increases, the point-to-multipoint system according to the present invention reduces system cost dramatically.

Within the satellite link, layer 2 frames (which encapsulate the IP packets) ensure that only IP packets destined to the remote ISP network behind a given router are processed at layer 3 (i.e., segregation). For the present invention, Ethernet protocol may be applied to encapsulate the IP packets. By enforcing the segregation at layer 2, IP packets not intended for a particular site at a remote ISP network are dropped by a router and are thus not evaluated at the IP layer of that remote ISP site for subsequent routing. As a result, the router of that remote ISP site is offloaded, and the aforementioned related art routing loop and related art policy-based problems are avoided. Since decisions are quickly and easily made at layer 2, a remote ISP router (e.g., 7a, also referred to as “router 2”) does not waste time on incoming IP packets that will be dropped because they were addressed to one of the other remote ISP routers (e.g., 7b, also referred to as “router 3”) sharing the link. The present invention is configured to achieve a performance similar to that of fast Ethernet based networks in a LAN environment, while also avoiding the bandwidth contention found in Ethernet-based networks.

An advantage of the layer 2 enforcement of unicast traffic according to the present invention is that no special consideration needs to be given to IP routing. As shown in Tables 1-4, each router 6, 7a, 7b . . . 7n has the typical routing entries necessary for Internet connection. Further, the core router 6 (also referred to as “router 1”) has a specific path configured for each remote ISP in accordance with the remote ISP networks for which that core router 6 is responsible. Each remote router (e.g., 7a) has a default path pointing to the core router to 6 reach the IP backbone service provider 1.

In the exemplary description of the present invention illustrated in FIG. 3, receivers 9a, 9b . . . 9n are used, corresponding to remote ISP networks 2a, 2b . . . 2n. However, the present invention is not limited thereto, and any number of receivers and remote ISP networks may be used. Each of the receiving IP addresses is assigned a fictitious (i.e., dummy) address, because each receiver must have a unique IP address for each port. While a number n of demodulators 10a, 10b . . . 10n is required at the IP backbone router 6, as in the related art, the present invention only requires a single modulator 11 at the IP backbone service provider 1.

At the MAC layer (i.e., OSI layer 2), it is necessary to statically configure an IP to MAC address resolution entry for each remote ISP router 2a . . . 2n. Although all remote ISP's 2a, 2b . . . 2n have the same default route, the IP to MAC resolution differs because each ISP has a separate interface for the upstream traffic to the core router 6. Further, although only receivers 9a, 9b . . . 9n are shown in FIG. 3, the number of receiving stations can be increased without complications.

TABLE 1
Router 1 ARP and IP Routing Tables

| IP Address | Type | Physical Address |
|---|---|---|
| Media Access Control | | |
| 192.168.3.2 | Static | 31-22-22-22-22-22 |
| 192.168.3.3 | Static | 31-33-33-33-33-33 |
| 192.168.3.4 | Static | 31-44-44-44-44-44 |
| Destination Network | Mask | NextHop Address |
| IP Routing | | |
| *Network B addresses | Mask B | 192.168.3.2 |
| *Network C addresses | Mask C | 192.168.3.3 |
| *Network D addresses | Mask D | 192.168.3.4 |

*These addresses are generated dynamically by routers 2 3 and 4

TABLE 2
Router 2 ARP and IP Routing Tables

| IP Address | Type | Physical Address |
|---|---|---|
| Media Access Control | | |
| 192.168.3.1 | Static | 31-11-11-11-11-11 |
| Destination Network | Mask | NextHop Address |
| IP Routing | | |
| 0.0.0.0 | 0.0.0.0 | 192.168.3.1 |

TABLE 3
Router 3 ARP and IP Routing Tables

| IP Address | Type | Physical Address |
|---|---|---|
| Media Access Control | | |
| 192.168.3.1 | Static | 41-11-11-11-11-11 |
| Destination Network | Mask | NextHop Address |
| IP Routing | | |
| 0.0.0.0 | 0.0.0.0 | 192.168.3.1 |

TABLE 4
Router 4 ARP and IP Routing Tables

| IP Address | Type | Physical Address |
|---|---|---|
| Media Access Control | | |
| 192.168.3.1 | Static | 51-11-11-11-11-11 |
| Destination Network | Mask | NextHop Address |
| IP Routing | | |
| 0.0.0.0 | 0.0.0 0 | 192.168.3.1 |

FIG. 4 illustrates a method of performing the exemplary embodiment of the present invention. In a first step S1, it determined if all of the ports are properly configured. If so, the step S3 is performed, as described in greater detail below. If not, then in the present invention, ports of each of the routers on the system need to be configured once for the correct MAC address in a configuration step S2. Each of the remote router tables includes one entry to provide for static IP to MAC translation, and vice versa, in the present invention. For IP packets flowing downstream, it is assumed that router 1 of the IP backbone service provider 1 in FIG. 3 terrestrially receives an IP packet from network A (i.e., Internet core), addressed to network C.

At step S3, the incoming IP packet that is outbound from the IP backbone service provider 1 is checked against the ARP table of router 1 (shown in Table 1), and in step S4 it is determined that the IP packet that matches a static route pointing to an address of router (i.e., 192.168.3.3) is the next hop. Next, since router 1 knows that router 3 is directly connected, router 1 checks the ARP table and determines that in order to send IP packets to router 3's address (192.168.3.3), the layer 2 encapsulation has a MAC address of 31-33-33-33-33-33, as shown in Table 1.

Then, at step S5, router 1 encapsulates the IP packet into a layer 2 frame, with a MAC address of 31-33-33-33-33-33, and sends the frame with the IP packet on to the modulator 11 at step S6. The modulator 11 is transparent to the IP packet, and modulates the base band signal to send the IP packet to the satellite 1. As a result, at step S7 the satellite 3 broadcasts the signal containing the IP packet over a satellite footprint, where the remote ISP's 2a . . . 2n are located. Accordingly, respective receivers 9a . . . 9n of the remote ISP's 2a . . . 2n receive the IP packet step S8.

At step S9, it is determined whether the MAC address of the incoming frame matches the MAC address of the receiving router. For example, but not by way of limitation, router 2 and router 4 receive the frame and evaluate the frame of the IP packet at layer 2. If there is no match in step S9, then the frame is dropped at step S10. In this example, routers 2 and 4 determine that the MAC destination address of the IP packet (i.e., 31-33-33-33-33-33) does not match their own MAC addresses (i.e., 31-22-22-22-22-22 and 31-44-44-44-44-44, respectively). Accordingly, router 2 and router 4 drop their entire frames (including the IP packets contained therein), and the IP packet never reaches the IP routing table for that remote ISP (i.e., Tables 2 and 4 for routers 2 and 4, respectively).

On the contrary, if there is a match in step S9, the encapsulating frame is stripped from the IP packet at step S11, and the IP packet is checked against the routing table at step S12, so that the IP packet can be transmitted to its final destination within the remote ISP network at step S13. In this example, router 3 inspects the frame and realizes that the MAC address corresponds to its interface (Table 3). At this point, router 3 takes the IP packet from the layer 2 frame (i.e., strips the encapsulating frame from the IP packet) and checks the IP packet against its IP routing table. Router 3 finds a match, because the IP packet is meant for one of the networks in its remote ISP network. Then, router 3 terrestrially forwards the IP packet to its final destination.

The foregoing example is for the case of IP packets flowing downstream (i.e., from back service provider 1 to remote ISPs 2a . . . 2n). However, a similar method can be performed in reverse to transmit IP packets from the remote ISP (e.g., 2b) to the IP backbone service provider 1 (i.e., IP packets flowing upstream). In an exemplary description of the upstream procedure, router 3 terrestrially receives an IP packet from the corresponding remote network (i.e., network C). The IP packet is destined to a network inside the Internet core (i.e., network A). Router 3 checks the destination IP address of the IP packet against its IP routing table, and finds no specific entry for the destination address of the IP packet. As a result, router 3 uses the default route to forward the IP packet.

From the IP routing table (i.e., Table3), router 3 knows that the next hop for its default route is IP address 192.168.3.1. Because router 3 knows that the provided IP address is directly connected, router 3 goes to the ARP table containing the MAC address and finds a static entry for that address, corresponding to a MAC address of 41-11-11-11-11-11 (see Table 3). Then, router 3 encapsulates the IP packet into a layer 2 frame, with a destination address of MAC 41-11-11-11-11-11, and sends the IP packet on to the modulator 12b.

The modulator 12b sends the IP packet to the satellite 3, which in turns broadcasts the IP packet. In this example, only router 1 has a demodulator (e.g., 10b) tuned to the transmitting frequency of router 3. Router 1 checks the MAC address, and determines that the frame is addressed to router 1. Next, router 1 checks the IP packet against its IP routing table, and terrestrially forwards the IP packet to network A (i.e., IP backbone service provider).

If the IP packet was intended for one of the other ISP's sharing the link instead of network A, then router 1 would send the IP packet over the 45 Mbit/s carrier with the corresponding MAC address (e.g., MAC address for router 2 or router 4) so that the IP packet reaches its destination (i.e., remote ISP network 2a or 2n), using the method illustrated in Figure and described above.

For the present invention, router 1 has two fictitious addresses configured, (i.e., 192.168.253.1 and 192.168.254.1), which could be any unused address outside the network space, because router 1 already has a port configured with network 192.1 68.3.X (at port 1), and some implementations do not allow the configuration of other serial interfaces in the same address space. As a result, additional interfaces are configured using the unused addresses. Because those other interfaces are used in a receive only mode, there is no problem with connecting those interfaces to a different network address. Unless a ping or telnet command is issued, IP packets arriving at those interfaces do not include their IP address, because they are usually meant for someone else. Thus, only a MAC address evaluation is made.

Another router may be added to the system as described below. The insertion of a new participating remote ISP to an existing point-to-multipoint network involves the configuration of a MAC to IP address translation entry for the core router, and another configuration for the new inserted router, in addition to the usual router configuration. To add a new router, the MAC address for the new router is added or retrieved, and configuration occurs at the remote side. Further, hardware is configured at the modem. A new row is added to the ARP table in the hub router (e.g., router 1), with the MAC address of the new router. Thus, the IP to MAC correspondence is created for the IP address in the remote ISP and the MAC address of the router. Accordingly, each port on the hub router has a different MAC address, but the same IP address. This occurrence is also reflected in the ARP table for the router for the new remote ISP network.

No downtime is necessary to add a new remote ISP, thus keeping the operation of the network intact in the process according to the present invention. This configuration process for the MAC address of the serial interface provides the ability to easily administer the numbering of the several interfaces participating in the satellite interconnection, as shown in the foregoing exemplary description.

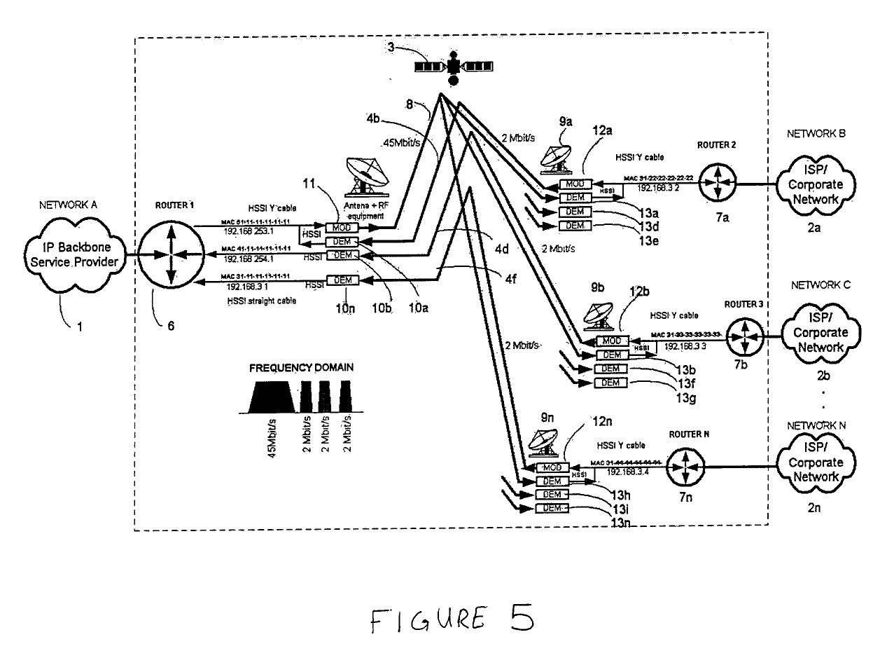

Further, various interconnection architectures may be used to implement the present invention. A typical star topology is used in the foregoing exemplary description of the present invention. However, the present invention is not limited thereto, and any satellite-based topology can be used, including full mesh, as illustrated in FIG. 5. In an extreme case of a fully meshed topology, the number of satellite carriers does not change from the star topology in the present invention. Every remote ISP should only have a single modulator. However, separate demodulators 13d-13i are provided, and are tuned to each others frequencies, as illustrated in FIG. 5, such that all remote ISPs can listen to one another (i.e., everyone can listen to everyone else's community).

In the related art system, “keep-alive” packets are periodically sent to a given port to determine if the port is active, and the port responds to inform the requesting port that the connection is available. However, related art “keep-alive” packets are not used in the present invention because the sending port will not receive a response at the hub (i.e., router 1). Accordingly, functionality of the keep alive packets is disabled in the present invention. Instead, a simple ping mechanism can be used between all ports involved.

Further, it is necessary to disable the keep-alive packets, because the address resolution protocol (ARP) and keep alive packets do not work when outbound and inbound packets do not traverse the same physical interface. Thus, only for router 1 to router 2 would ARP work with keep-alive packets. Therefore, at router 1, separate entries are necessary for traffic to routers 2, 3 and 4 (see Table 1). At routers 2, 3 and 4, a single static MAC entry is necessary for the router to know what MAC address to use when encapsulating IP packets as shown in Tables 2-4. This MAC to IP static resolution is configured once, and involves one entry for the core router and one remote router for each new remote ISP that shares the link.

Additional alternate embodiments are possible for the present invention. For example, but not by way of limitation, because layer 2 operates similarly for the related art FR, ATM and DVB systems, the present invention can also be applied to those systems, thus resulting in the similar advantages, as discussed in greater detail below. Also, the output port of the router 1 may be used as a return channel input port as well. However, it is noted that having a separate port for the return channel results in a cheaper interface at the router, and results in a further cost saving.

Further, the illustrated embodiments are not meant to limit the present invention to those implementations. For example, but not by way of limitation, an HSSI standard Y cable and an HSSI straight cable are illustrated at the output of router 1. However, any similar device may be used therein.

The present invention has various advantages. For example, but not by way of limitation, the present invention has improved efficiency, as more Mbit/s can be transported for a given frequency in a transponder. Further, the present invention IP uses statistical multiplexing by having the ISPs share a single high speed downstream link among various ISP's results in additional efficiency gains. The ISPs can share a common downlink channel and have separate bandwidth to accommodate the variable bandwidth demand at each of the ISPs. In addition, for maximum use of power and bandwidth, the present invention allows operation of the transponder near saturation while not having to rely on complex TDMA systems. Also, when the satellite footprint covers a region where time zones are different, time-of-the-day traffic rotation is possible. Additionally, in the aforementioned mesh network embodiment of the present invention, all of the remote ISP's can listen, as illustrated in FIG. 5.

The present invention has at least an additional advantage in that no special consideration is required for routing, since the operation is handed seamlessly at layer 2, and no extra devices are necessary to implement the present invention, other than the conventional equipment in an Internet interconnection over satellite, such as (but not limited to) satellite modems and routers. The present invention also requires less modulators than traditional point-to-point systems, as the simplicity of MAC (layer 2) framing, combined with the shared downstream link, makes the present invention easy to operate and scalable, thus resulting a hardware savings.

It will be apparent to those skilled in the art that various modifications and variations can be made to the described exemplary embodiments of the present invention without departing from the spirit or scope of the invention. Thus, it is intended that the present invention cover all modifications and variations of this invention consistent with the scope of the appended claims and their equivalents.

What is claimed is:

1. A method of communication between a first Internet Service Provider (ISP) and at least one second Internet Service Provider (ISP) via a satellite, comprising:
(a) at a first router coupled to said first ISP, determining a static route for an IP packet of said first ISP in accordance with a media access control (MAC) address of a destination router for said IP packet;
(b) encapsulating and transporting, via said satellite, said IP packet in a frame having said MAC address of said destination router in accordance with a static entry in an address resolution protocol (ARP) table;
(c) in a second router coupled to said at least one second ISP, receiving said frame containing said IP packet; and
(d) making a transportation decision for said IP packet prior to arrival at said at least one second ISP.

2. The method of claim 1, wherein said first ISP is an IP backbone service provider and said at least one second ISP is remote with respect to said first ISP.

3. The method of claim 1, wherein said at least one second ISP is an IP backbone service provider and said first ISP is a remote ISP, and said (d) comprises transporting said IP packet to said IP backbone service provider as a default path represented by a predetermined IP address in an IP routing table in said first router.

4. The method of claim 1, wherein said method is performed in one of a star network and a full mesh network.

5. The method of claim 1, wherein an Ethernet protocol is applied to encapsulate and transport said IP packet in said frame.

6. The method of claim 1, wherein said steps (a)-(d) are performed without keep alive packets.

7. The method of claim 1, wherein said step (a) comprises matching said MAC destination address with an entry in the address resolution protocol (ARP) table in said first router, and said step (b) is performed in said first router.

8. The method of claim 1, said step (d) comprising one of:
(i) stripping said frame from said IP packet and transporting said IP packet to said destination if said MAC address of said destination router matches a MAC address of said second router, and
(ii) dropping said frame at said second router, and prior to transmission to said at least one second ISP, if said MAC address of said destination router does not match a MAC address of said second router.

9. The method of claim 1, wherein said first router has a single output coupled to a modulator, and a number of inputs, coupled to corresponding demodulators and equal to a number of said at least one second ISP, and said single output and one of said inputs shares a common port.

10. The method of claim 10, wherein a number of modulators is one greater than said number of said at least one second ISP, and a number of demodulators is twice said number of said at least one second ISP.

11. A system for satellite communication between a first Internet Service Provider (ISP) and at least one second ISP, comprising:
a first router coupled to said first ISP and a second router coupled to said second ISP;
a shared channel configured to encapsulate an IP packet in a frame and said frame containing said IP packet from said first ISP to said at least one second ISP in accordance with a media access control (MAC) address determined in said first router,
wherein said second router is operative to one of (a) drop said IP packet prior to reaching said at least one second ISP, and (b) transport said IP packet to a final destination in said at least one second ISP, in accordance with said MAC address of said IP packet and a MAC address of said second router.

12. The system of claim 11, wherein said first ISP is an IP backbone service provider and said at least one second ISP is a remote ISP.

13. The system of claim 11, wherein said at least one second ISP is an IP backbone service provider and said first ISP is a remote ISP, and said IP packet is transported to said IP backbone service provider via a default path represented by an address in a routing table in said first router.

14. The system of claim 11, wherein said system comprises one of a star network and a full mesh network.

15. The system of claim 11, wherein said frame comprises an Ethernet protocol frame that encapsulates said IP packet for transport to said at least one second ISP.

16. The system of claim 11, wherein said system does not generate keep-alive packets.

17. The system of claim 11, wherein said MAC destination address is matched with an entry in an address resolution protocol (ARP) table and encapsulated in said frame in said first router.

18. The system of claim 11, wherein said second router is operative to one of (a) strip said frame from said IP packet and transport said IP packet to said destination if said determined MAC address of said destination server matches a MAC address of said second router, and (b) drop said frame at said second router and prior to transmission to said at least one second ISP if said MAC address of said destination server does not match a MAC address of said second router.

19. The system of claim 11, wherein said first router has a single output coupled to a modulator, and a number of inputs, coupled to corresponding demodulators and equal to a number of said at least one second ISP, and said single output and one of said inputs sharing a common port.

20. The system of claim 19, wherein a number of modulators is one greater than said number of said at least one second ISP, and a number of demodulators is twice said number of said at least one second ISP.
